(19) United States
(12) Patent Application Publication
(10) Pub. No.: US 2025/0117715 A1
(43) Pub. Date: Apr. 10, 2025

(54) FLIGHT SERVICE SYSTEM

(71) Applicant: TOYOTA JIDOSHA KABUSHIKI KAISHA, Aichi-ken (JP)

(72) Inventors: Shotaro SUZUKI, Nagakute-shi (JP); Daiki KANEICHI, Tokyo-to (JP)

(21) Appl. No.: 18/882,754

(22) Filed: Sep. 12, 2024

(30) Foreign Application Priority Data
Oct. 4, 2023 (JP) 2023-172695

(51) Int. Cl. G06Q 10/02; G06F 16/9536; G06F 16/9537

(52) U.S. Cl. CPC G06Q 10/02; G06F 16/9536; G06F 16/9537

(57) ABSTRACT

A flight service system provides a flight service using an eVTOL. The flight service system includes one or more processors and one or more storage devices. The one or more storage devices are configured to store a database in which information of a recommended spot group recommended by a user group using the flight service is accumulated. The one or more processors are configured to acquire information on a specified recommended spot, which is specified by a target user who desires to use the flight service, among the recommended spot group accumulated in the database. The one or more processors are further configured to determine a flight route for the target user so as to pass through the specified recommended spot.

### CROSS-REFERENCES TO RELATED APPLICATION

The present disclosure claims priority to Japanese Patent Application No. 2023-172695, filed on Oct. 4, 2023, the contents of which application are incorporated herein by reference in their entirety.

### TECHNICAL FIELD

The present disclosure relates to a technique for providing a flight service using an electric vertical take-off and landing aircraft (eVTOL).

### BACKGROUND ART

Patent Literature 1 discloses a technique for providing a mobility service using an eVTOL. In response to a reservation request from a user, an itinerary including a flight from a first takeoff and landing site to a second takeoff and landing site is created.

### LIST OF RELATED ART

Patent Literature 1: Japanese Laid-Open Patent Application No. JP-2022-019193

### SUMMARY

It is desired to increase an opportunity to use a flight service using an eVTOL.

An aspect of the present disclosure is directed to a flight service system for providing a flight service using an eVTOL.

The flight service system includes one or more processors and one or more storage devices.

The one or more storage devices are configured to store a database in which information of a recommended spot group recommended by a user group using the flight service is accumulated.

The one or more processors acquire information on a specified recommended spot, which is specified by a target user who desires to use the flight service, among the recommended spot group accumulated in the database. Then, the one or more processors determine a flight route for the target user so as to pass through the specified recommended spot.

According to the present disclosure, the recommended spot database is prepared in which information of the recommended spot group recommended by the user group using the flight service is accumulated. The target user who desires to use the flight service can specify one or more recommended spots among the recommended spot group accumulated in the recommended spot database. Then, the flight route for the target user is determined so as to pass through the specified recommended spot. Thus, the target user is able to go from a point of departure to a destination via the specified recommended spot. That is, the target user is able to have an experience unique to the eVTOL, which cannot be experienced in a case of a normal passenger aircraft. This improves the user's satisfaction with the flight service using the eVTOL. As a result, the opportunity to use the flight service using the eVTOL increases.

### BRIEF DESCRIPTION OF DRAWINGS

FIG. 1 is a conceptual diagram for explaining an overview of a flight service system;

FIG. 2 is a conceptual diagram for explaining a recommended spot database;

FIG. 3 is a conceptual diagram for explaining recommended spot reservation and schedule adjustment;

FIG. 4 is a conceptual diagram for explaining recommended spot reservation information;

FIG. 5 is a block diagram showing an example of a configuration of a management system; and

FIG. 6 is a flowchart showing an example of processing related to flight service reservation.

### DETAILED DESCRIPTION

Embodiments of the present disclosure will be described with reference to the accompanying drawings.

### 1. Overview of Flight Service System

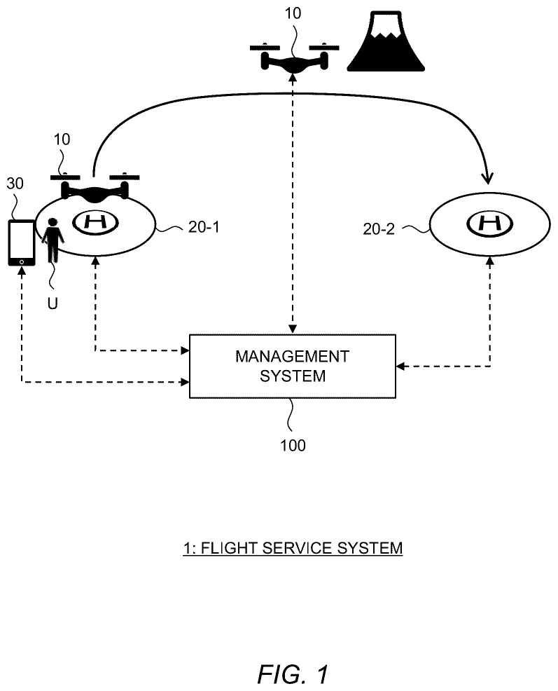

FIG. 1 is a conceptual diagram for explaining an overview of a flight service system 1 according to the present embodiment. The flight service system 1 provides a flight service using an electric vertical take-off and landing aircraft (eVTOL) 10.

The eVTOL 10 is a small, lightweight VTOL driven by an electric motor. More specifically, the eVTOL 10 includes a rotor, a power unit, and a control device. The power unit includes an electric motor for rotating the rotor, a battery for supplying electric power to the electric motor, and the like. The battery is, for example, a storage battery such as an all-solid-state battery. Alternatively, the battery may be a fuel cell. The control device the power device to control the flight of the eVTOL 10. Such an eVTOL 10 has features of space saving, low costs, and low noise, as compared with a general aircraft. The eVTOL 10 can also be stopped in the air or rotated in place. Thus, the eVTOL 10 can create a new experience that cannot be experienced by a normal passenger aircraft.

The takeoff and landing site 20 is a place where the eVTOL 10 takes off or lands. The takeoff and landing site 20 may include a charging facility, a battery exchange facility, a maintenance facility, and the like. Examples of the takeoff and landing site 20 include airports, airports, heliports, building rooftops, eVTOL hangars, and the like. As another example, the takeoff and landing site 20 may be a car dealer. By using the dealer as the takeoff and landing site 20, it is possible to seamlessly connect a ground mobility service using an automobile and a flight service using a eVTOL 10. Further, both mobility services can be provided in one stop.

In FIG. 1, the takeoff and landing site 20-1 is a point of departure, and the takeoff and landing site 20-2 is a destination. The user U of the flight service boards the eVTOL 10 at the takeoff and landing site 20-1. The eVTOL 10 with the user U takes off from the takeoff and landing site 20-1, flies toward the takeoff and landing site 20-2, and lands on the takeoff and landing site 20-2. The user U gets off the eVTOL 10 landed on the takeoff and landing site 20-2.

The user terminal 30 is a terminal used by the user U. Examples of the user terminal 30 include a smartphone, a tablet, a PC, and the like.

The management system 100 manages the entire flight service. For example, the management system 100 performs management of the eVTOL 10, management of the takeoff and landing site 20, reception of a flight reservation from the user U, determination of an itinerary (a flight route and a flight schedule) for the user U, and the like. The management system 100 can communicate with terminal installed in the eVTOL 10 and the takeoff and landing site 20 and the user terminal 30. Typically, the management system 100 performs wireless communication. The management system 100 may be configured by a single management server or a plurality of management servers that perform distributed processing.

As described above, the eVTOL 10 can stop in the air or rotate in place. Thus, the eVTOL 10 can create a new experience that cannot be experienced by a normal passenger aircraft. For example, the eVTOL 10 may stop at a spot where a beautiful view can be seen during a flight from the takeoff and landing site 20-1 (point of departure) to the takeoff and landing site 20-2 (destination site). The user U riding in the eVTOL 10 can enjoy a beautiful view from the spot at a desired angle.

According to the present embodiment, the user U who has used eVTOL 10 can register a spot that can be recommended to others from his/her experience as a “recommended spot” in the management system 100. The management system 100 accumulates information on recommended spots collected from various users U in a database. Such a database is hereinafter referred to as “recommended spot database 200.”

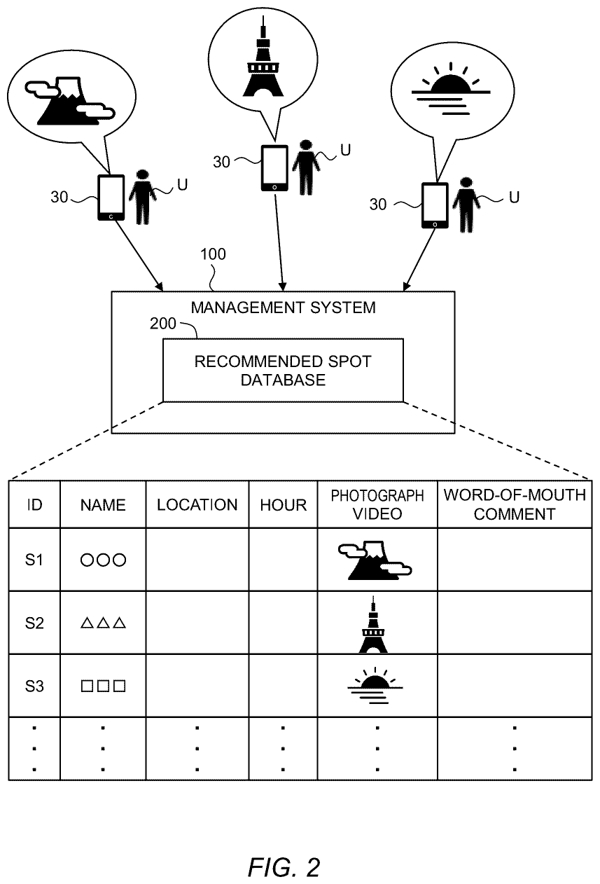

FIG. 2 is a conceptual diagram for explaining the recommended spot database 200. The recommended spot database 200 is a database in which information of a recommended spot group recommended by one or a plurality of users U (hereinafter, referred to as a “user group”) who use the flight service is accumulated. The recommended spot database 200 has an entry for each recommended spot. Each entry includes identification information (ID), a name, a position (latitude, longitude, and altitude), hour, a photograph, a video, word-of-mouth information, a comment, and the like of a recommended spot.

The user U who has used the flight service can register information on the recommended spot in the recommended spot database 200 by operating the user terminal 30. For example, the user U activates the flight service application on the user terminal 30 and inputs information on a recommended spot. The position of the recommended spot can be acquired from the current position information of the eVTOL 10 or the flight route. For example, during the flight, the user U presses a predetermined button of the application at a spot to be recommended. The application acquires the current position information in cooperation with the eVTOL 10. As another example, the app may acquire information on a flight route from the management system 100 and display the flight route on the display device of the user terminal 30. The user U may specify a recommended spot by viewing the displayed flight route. The user terminal 30 transmits information on the recommended spot input by the user U to the management system 100. The management system 100 adds the information about the recommended spot sent from the user terminal 30 to the recommended spot database 200.

The recommended spot database 200 created and updated in this way can be used by the user U who will use the flight service, that is, the user U who wants to use the flight service. The user U who will use the flight service, that is, the user U who desires to use the flight service will be hereinafter referred to as a “target user.”

The management system 100 presents (recommends) one or more of the recommended spot groups accumulated in the recommended spot database 200 to the target user via the user terminal 30. The target user operates the user terminal 30 to specify a recommended spot that the user wants to stop at.

For example, the target user first operates the user terminal 30 to specify a point of departure (the takeoff and landing site 20-1) and a destination (the takeoff and landing site 20-2). The management system 100 acquires information on a point of departure and a destination specified by the target user. The management system 100 extracts a recommended spot candidate existing in a predetermined area between a point of departure and a destination from a recommended spot group accumulated in a recommended spot database 200. The predetermined area between the point of departure and the destination is, for example, an area reachable within a certain time from the shortest route between the point of departure and the destination. The predetermined area between the point of departure and the destination may be an area within a certain distance from the shortest route between the point of departure and the destination. The management system 100 presents (recommends) the recommended spot candidates to the target user via the user terminal 30 of the target user. The target user operates the user terminal 30 to specify a recommended spot that the target user wants to stop at from among the recommended spot candidates. The recommended spot specified by the target user is hereinafter referred to as a “specified recommended spot.” The management system 100 acquires information on the specified recommended spot. Then, the management system 100 determines the flight route for the target user so as to pass through the specified recommended spot specified by the target user.

As another example, the management system 100 may present (recommend) the recommended spot group accumulated in the recommended spot database 200 to the target user via the user terminal 30 of the target user. The target user operates the user terminal 30 to specify a recommended spot that the target user wants to stop at from the recommended spot group. The management system 100 acquires information on a specified recommended spot specified by the target user. The management system 100 selects a point of departure (takeoff and landing site 20-1) and a destination (takeoff and landing site 20-2) where access to the specified recommended spot is easy. Then, the management system 100 determines a flight route for the target user so as to pass through the specified recommended spot.

As described above, according to the present embodiment, the recommended spot database 200 is prepared in which the information of the recommended spot group recommended by the user group using the flight service is accumulated. The target user who desires to use the flight service can specify one or more recommended spots among the recommended spot group accumulated in the recommended spot database 200. Then, the flight route for the target user is determined so as to pass through the specified recommended spot. Thus, the target user is able to go from the point of departure to the destination via the specified recommended spot. That is, the target user is able to have an experience unique to the eVTOL 10, which cannot be experienced in a case of a normal passenger aircraft. Thus, the satisfaction of the user U with respect to the flight service using the eVTOL 10 is improved. As a result, the opportunity to use the flight service using the eVTOL 10 increases.

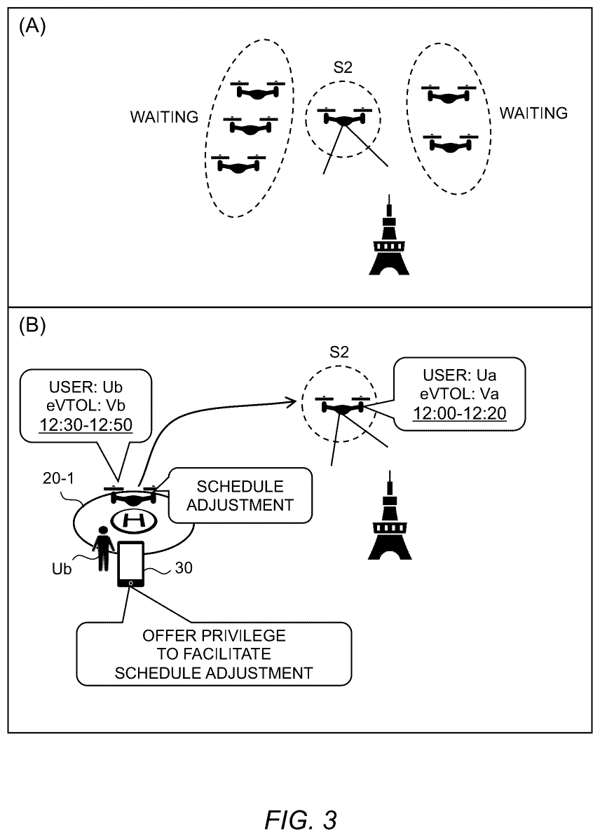

Next, with reference to FIG. 3, reservation of a recommended spot will be considered. A popular recommended spot may be crowded with many eVTOL 10, and may cause a waiting in the sky. For example, (A) in FIG. 3 illustrates a situation in which many eVTOL 10 are gathered around a popular recommended spot S2. While a certain eVTOL 10 stays at the recommended spot S2, another eVTOL 10 waiting for its turn stands by (hovers) around the recommended spot S2. Therefore, the eVTOL 10 waiting for its turn during the time period wastefully consumes electric power. Further, it is not preferable in terms of safety that a large number of eVTOLs 10 gather in a narrow area.

Therefore, the recommended spot may be reserved. In the example illustrated in (B) in FIG. 3, regarding the recommended spot S2, the time 12:00 to 12:20 is allocated to the user Ua, and the time 12:30 to 12:50 is allocated to the user Ub. That is, the reservation time of the recommended spot S2 is 12:00 to 12:20 for the user Ua and 12:30 to 12:50 for the user Ub.

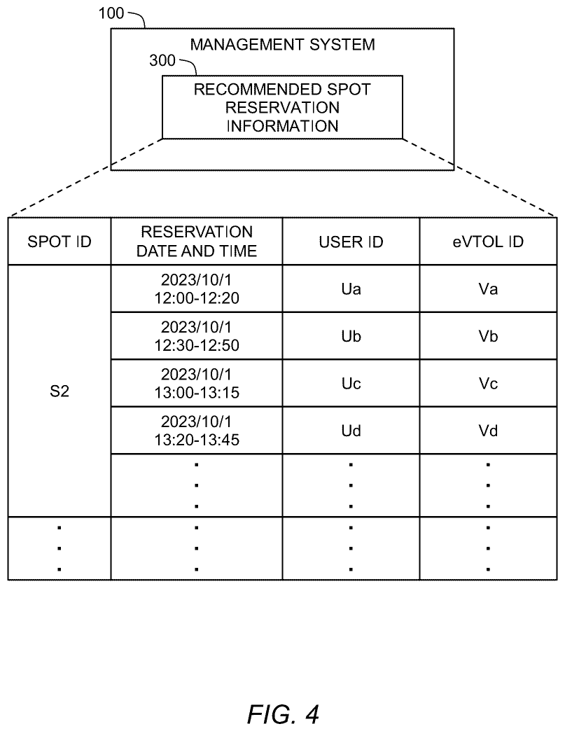

As shown in FIG. 4, the management system 100 may hold recommended spot reservation information 300 for managing reservations of recommended spots. The recommended spot reservation information 300 indicates the current reservation status for each recommended spot. The target user who desires to use the flight service can reserve the available time with reference to the recommended spot reservation information 300.

More specifically, the management system 100 extracts the available time (usable time) related to the specified recommended spot specified by the target user from the recommended spot reservation information 300. Then, the management system 100 presents information on the available time related to the specified recommended spot to the target user via the user terminal 30. The target user operates the user terminal 30 to specify a desired reservation time from among the presented available times. The user terminal 30 transmits information on the reservation time specified by the target user to the management system 100. The management system 100 allocates the specified reservation time to the target user and updates the recommended spot reservation information 300.

Alternatively, the management system 100 may automatically allocate an appropriate available time to the target user as the reservation time.

When determining the flight schedule for the target user, the management system 100 acquires information on the reservation time of the specified recommended spot assigned to the target user from the recommended spot reservation information 300. Then, the management system 100 determines the flight schedule for the target user so that the target eVTOL where the target user boards arrives at the specified recommended spot before the reservation time.

In this way, by setting the recommended spot to the eVTOL 10 system, it is possible to suppress a plurality of reservations from concentrating on the same recommended spot at the same time. Thus, the occurrence of waiting in the sky is suppressed. Since the hovering for waiting for the turn is also suppressed, unnecessary power consumption is suppressed. Further, the concentration of a large amount of eVTOLs 10 in a narrow area is also suppressed. This is preferable from the viewpoint of safety.

The management system 100 may determine the flight schedule for the target user such that the target eVTOL where the target user boards arrives at the specified recommended spot at the reserved time without waiting in the sky. In this case, unnecessary power consumption is minimized.

The process of determining the flight schedule for the target user in consideration of the reservation time of the specified recommended spot assigned to the target user as described above is referred to as a “schedule adjustment process.” For the schedule adjustment process, it may be necessary to change the departure time of the target eVTOL from the initial departure time desired by the target user. When the departure time of the target eVTOL needs to be changed from the original departure time desired by the target user, the management system 100 may offer a privilege to the target user via the user terminal 30 of the target user. Examples of the privilege include discount, points, and coupons. Offering the privilege to the target user can promote the target user to accept the schedule adjustment process. As a result, the possibility of suppressing unnecessary power consumption increases. The reservation fee of the recommended spot may vary depending on the season or the time zone (dynamic pricing). For example, the reservation fee of a recommended spot at which the evening sun is clearly visible is high in the evening time zone.

### 2. Configuration Example of Management System

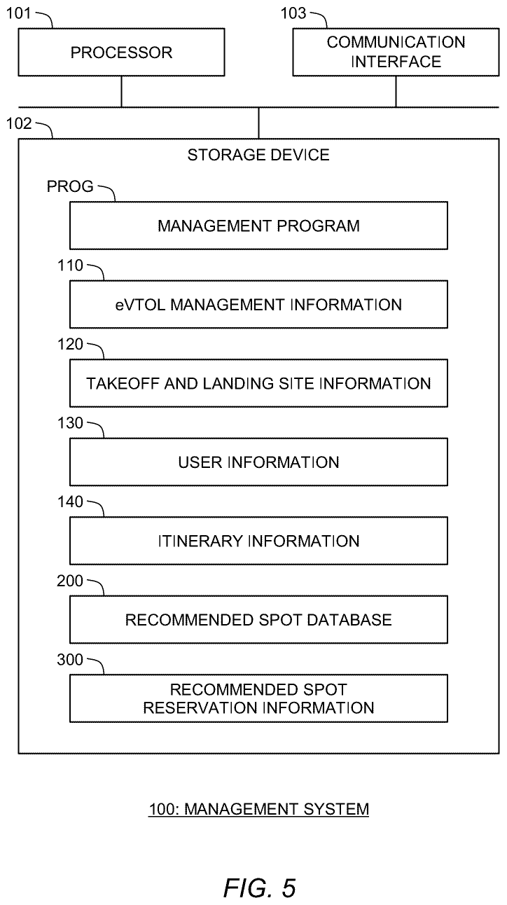

FIG. 5 is a block diagram illustrating an example of the configuration of the management system 100. The management system 100 includes one or more processors 101 (hereinafter, simply referred to as a processor 101 or processing circuitry), one or more storage device 102 (hereinafter, simply referred to as a storage device 102), and a communication interface 103.

The processor 101 (processing circuitry) executes a variety of processing. For example, the processor 101 performs management of the eVTOL 10, management of the takeoff and landing site 20, reception of a flight reservation from the user U, determination of an itinerary (a flight route and a flight schedule) for the user U, and the like. Examples of the processor 101 include a central processing unit (CPU), a graphics processing unit (GPU), an application specific integrated circuit (ASIC), a field-programmable gate array (FPGA), and the like.

The storage device 102 stores a variety of information. Examples of the storage device 102 include a volatile memory, a nonvolatile memory, a hard disk drive (HDD), a solid state drive (SSD), and the like.

The communication interface 103 is communicably connected to terminal installed in each eVTOL 10 and each takeoff and landing site 20, the user terminal 30, and the like. The processor 101 communicates with the terminal installed in each eVTOL 10 and each takeoff and landing site 20, the user terminal 30, and the like via the communication interface 103.

A management program PROG is a computer program executed by the processor 101. The functions of the management system 100 may be implemented by cooperation between the processor 101 that executes the management program PROG and the storage device 102. The management program PROG is stored in the storage device 102. Alternatively, the management program PROG may be recorded on a non-transitory computer-readable recording medium.

The storage device 102 stores eVTOL management information 110, takeoff and landing site information 120, user information 130, itinerary information 140, the recommended spot database 200, the recommended spot reservation information 300, and the like.

The eVTOL management information 110 is information for managing each eVTOL 10. For example, the eVTOL management information 110 includes the machine IDs, the position information, the capability information, the state information, the schedule information, and the like of each eVTOL 10. The position information is measured by a global navigation satellite system (GNSS) or an altimeter mounted on the eVTOL 10 and is transmitted from the eVTOL 10 to the management system 100. The performance information includes a cruising distance, a maximum flight speed, battery performance, and the like. The state information includes an operation state (standby, flying), a flying speed, and the like, and is transmitted from the eVTOL 10 to the management system 100. The schedule information indicates a flight schedule and a flight route of the eVTOL 10.

The takeoff and landing site information 120 is information related to each takeoff and landing site 20. For example, the takeoff and landing site information 120 includes the ID, position information, facility information, schedule information, and the like of each takeoff and landing site 20. The position information (latitude and longitude) of each takeoff and landing site 20 is known information. The facility information indicates the presence or absence of a charging facility, the presence or absence of a maintenance facility, and the like. The schedule information indicates which eVTOL 10 is present (available) at each takeoff and landing site 20 and when.

The user information 130 is information related to the user U of the flight service. For example, the user information 130 includes a user ID, registration information, reservation information, usage history information, and the like of each user U.

The itinerary information 140 is information related to an itinerary of a flight reserved by the user U. For example, the itinerary information 140 includes itinerary IDs, user IDs of the users U, machine IDs of the eVTOL 10 to be used, point of departures (first takeoff and landing sites 20-1), destinations (second takeoff and landing sites 20-2), flight routes, flight schedules (departure times, arrival times, required times), flight fares, and the like. The itinerary information 140 may include a specified recommended spot and a reservation time thereof.

The recommended spot database 200 is as described above (see FIG. 2). The recommended spot database 200 is a database in which information of a recommended spot group recommended by a user group using the flight service is accumulated. The user terminal 30 transmits information on the recommended spot input by the user U to the management system 100. The processor 101 adds the information on the recommended spot transmitted from the user terminal 30 to the recommended spot database 200.

The recommended spot reservation information 300 is as described above (see FIG. 3). The recommended spot reservation information 300 indicates the current reservation status for each recommended spot. The target user who desires to use the flight service can reserve the available time with reference to the recommended spot reservation information 300. The user terminal 30 transmits information on the reservation time specified by the target user to the management system 100. The processor 101 allocates the specified reservation time to the target user and updates the recommended spot reservation information 300.

### 3. Processing Example

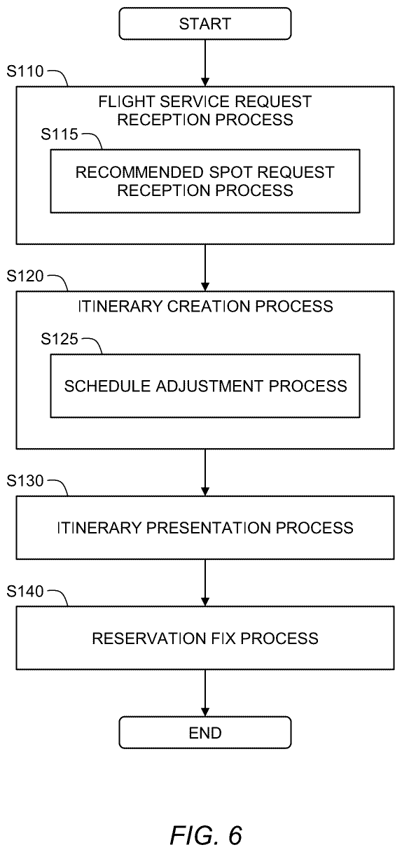

FIG. 6 is a flowchart illustrating an example of a process related to flight service reservation. A target user who desires to use the flight service starts the flight service application on the user terminal 30.

In Step S110, the processor 101 receives a flight service request from a target user who desires to use a flight service. For example, the flight service request includes a desired use date, a desired departure time, a desired arrival time, a point of departure (the takeoff and landing site 20-1), a destination (the takeoff and landing site 20-2), and the like. The flight service request corresponds to search information for the target user to search for a flight service. More specifically, the target user inputs a flight service request using the user terminal 30. The user terminal 30 transmits the input flight service request to the management system 100. The processor 101 of the management system 100 receives the flight service request via the communication interface 103. The processor 101 stores the received flight service request in the storage device 102.

Further, the processor 101 may receive a reservation for a recommended spot to which the user wants to stop during the flight from the target user (Step S115).

For example, the processor 101 extracts recommended spot candidates existing in a predetermined area between the point of departure (the takeoff and landing place 20-1) and the destination (the takeoff and landing place 20-2) from the recommended spot group accumulated in the recommended spot database 200. The information of the point of departure and the destination is included in the flight service request. The predetermined area between the point of departure and the destination is, for example, an area reachable within a certain time from the shortest route between the point of departure and the destination. The predetermined area between the point of departure and the destination may be an area within a certain distance from the shortest route between the point of departure and the destination. The processor 101 transmits information on the extracted recommended spot candidate to the user terminal 30 of the target user via the communication interface 103. The user terminal 30 presents the recommended spot candidate to the target user. The target user operates the user terminal 30 to specify a recommended spot that the target user wants to stop at from among the recommended spot candidates. The user terminal 30 transmits information on the specified recommended spot to the management system 100. The processor 101 receives the information on the specified recommended spot via the communication interface 103. The processor 101 stores the information of the specified recommended spot in the storage device 102.

As another example, the processor 101 may transmit information of the recommended spot group accumulated in the recommended spot database 200 to the user terminal 30 of the target user via the communication interface 103. The user terminal 30 presents the recommended spot group to the target user. The target user operates the user terminal 30 to specify a recommended spot that the target user wants to stop at from the recommended spot group. The user terminal 30 transmits information on the specified recommended spot to the management system 100. The processor 101 receives the information on the specified recommended spot via the communication interface 103. Then, the processor 101 may select a point of departure (the takeoff and landing site 20-1) and a destination (the takeoff and landing site 20-2) where the specified recommended spot is easily accessible. The processor 101 stores information on the point of departure, the destination, and the specified recommended spot in the storage device 102.

The recommended spot may be reserved. In this case, the processor 101 extracts the available time (usable time) related to the specified recommended spot from the recommended spot reservation information 300. The processor 101 transmits the information of the available time related to the specified recommended spot to the user terminal 30 of the target user via the communication interface 103. The user terminal 30 presents the available time related to the specified recommended spot to the target user. The target user operates the user terminal 30 to specify a desired reservation time from among the presented available times. The user terminal 30 transmits information on the reservation time specified by the target user to the management system 100. The processor 101 receives information regarding the specified reservation time via the communication interface 103. The processor 101 allocates the specified reservation time to the target user and updates the recommended spot reservation information 300.

In Step S120, the processor 101 executes an “itinerary creation process” of creating one or more itineraries from the point of departure (the takeoff and landing site 20-1) to the destination (the takeoff and landing site 20-2) in response to the flight service request. For example, the processor 101 selects eVTOL available at the point of departure at the desired departure time on the desired use date based on the eVTOL management information 110 and the takeoff and landing site information 120. The processor 101 acquires position information of the point of departure and the destination based on the takeoff and landing place information 120. The processor 101 then determines one or more flight routes from the origin to the destination.

When the specified recommended spot is specified by the target user, the processor 101 determines one or more flight routes so as to pass through the specified recommended spot.

When the reservation time of the specified recommended spot is allocated to the target user, the processor 101 performs the schedule adjustment process (Step S125). In the schedule adjustment process, the processor 101 determines one or more flight schedules in consideration of the reservation time of the specified recommended spot assigned to the target user. More specifically, the processor 101 determines one or more flight schedules such that the target eVTOL boarded by the target user arrives at the specified recommended spot before the reservation time. The processor 101 may determine one or more flight schedules such that the target eVTOL arrives at the specified recommended spot at the reserved time without waiting in the sky. When the departure time of the target eVTOL needs to be changed from the original departure time desired by the target user, the processor 101 may offer a privilege to the target user via the user terminal 30 of the target user.

In Step S130, the processor 101 presents a tentative itinerary information to the target user. The tentative itinerary information includes a point of departure, a destination, a flight route, a flight schedule (departure time, arrival time, required time), information of a target eVTOL, and the like. The tentative itinerary information may include the specified recommended spot and the reservation time thereof. The tentative itinerary information may include fee information. The processor 101 transmits the tentative itinerary information to the user terminal 30 of the target user via the communication interface 103. The user terminal 30 presents the tentative itinerary information to the target user.

In Step S140, the target user examines the presented tentative itinerary information and determines whether or not to fix the reservation. When a plurality of itineraries are presented, the target user selects one of the plurality of itineraries. For example, the target user performs determination and selection with reference to the required time and the usage fee. If the presented tentative itinerary information is not approved, the target user may change the flight service request. In this case, the processing returns to Step S110.

When fixing the reservation, the target user instructs the reservation fix by using the user terminal 30. When a plurality of itineraries are presented, the target user specifies one of the itineraries. The user terminal 30 transmits a reservation fix request to the management system 100. The processor 101 of the management system 100 receives the reservation fix request via the communication interface 103. In response to the reservation fix request, the processor 101 fixes the itinerary information related to the target user. The processor 101 updates the eVTOL management information 110, the takeoff and landing site information 120, the user information 130, and the itinerary information 140 based on the itinerary information related to the target user.

What is claimed is:

1. A flight service system for providing a flight service using an eVTOL, the flight service system comprising:
processing circuitry; and
one or more storage devices configured to store a database in which information of a recommended spot group recommended by a user group using the flight service is accumulated, wherein
the processing circuitry is configured to:
acquire information on a specified recommended spot, which is specified by a target user who desires to use the flight service, among the recommended spot group accumulated in the database; and
determine a flight route for the target user so as to pass through the specified recommended spot.

2. The flight service system according to claim 1, wherein
the processing circuitry is further configured to:
acquire information on a point of departure and a destination specified by the target user;
extract a recommended spot candidate present in a predetermined area between the point of departure and the destination from the recommended spot group accumulated in the database; and
present the recommended spot candidate to the target user via a user terminal of the target user.

3. The flight service system according to claim 1, wherein
each recommended spot included in the recommended spot group requires reservation, and
the processing circuitry is further configured to:
acquire information on a reservation time of the specified recommended spot allocated to the target user; and
determine a flight schedule for the target user such that a target eVTOL boarded by the target user arrives at the specified recommended spot before the reservation time.

4. The flight service system according to claim 3, wherein
the processing circuitry is configured to determine the flight schedule for the target user such that the target eVTOL arrives at the specified recommended spot at the reservation time without waiting in sky.

5. The flight service system according to claim 3, wherein
when a departure time of the target eVTOL needs to be changed from an original departure time desired by the target user, the processing circuitry is further configured to offer a privilege to the target user via a user terminal of the target user.
